(19) United States
(12) Patent Application Publication
(10) Pub. No.: US 2013/0339459 A1
(43) Pub. Date: Dec. 19, 2013

(54) INFORMATION SHARING APPARATUS, INFORMATION SHARING SYSTEM, AND METHOD OF PROCESSING INFORMATION

(71) Applicant: Hiroya KUMASHIO, Chiba (JP)

(72) Inventor: Hiroya KUMASHIO, Chiba (JP)

(73) Assignee: RICOH COMPANY, LTD., Tokyo (JP)

(21) Appl. No.: 13/905,288

(22) Filed: May 30, 2013

(30) Foreign Application Priority Data
Jun. 13, 2012 (JP) 2012-134205

(51) Int. Cl. H04L 12/58

(52) U.S. Cl. CPC H04L 51/00
USPC 709/206

(57) ABSTRACT

An information sharing apparatus for sharing an operation on contents with another apparatus includes a generating part configured to generate a message containing a command corresponding to the operation on the contents, a sending part configured to send the message to a server, which delivers the message to the another apparatus, an interpreting part configured to interpret the message to obtain the command, and an updating part configured to update a display of the contents based on the obtained command.

### BACKGROUND OF THE INVENTION

1. Field of the Invention

The present invention relates to an information sharing apparatus, an information sharing system, and a method of processing information.

2. Description of the Related Art

As disclosed in patent document 1, in an example of a conference supporting system of electrically supporting a conference, information publicly provided by an individual participant is delivered to portable terminals of all participants or a screen which can be commonly viewed by all the participants. Further, such shared information simultaneously undergoes editing operations performed by all the participants. Then, the shared information resultantly obtained is shown (using a display or the like) in real time without causing contradictions.

However, a dedicated program is required to be prepared in a system to perform the above function. Therefore, there is a problem that a program is complicated. Such a problem is a common issue for information sharing systems that share information.
Patent Document 1: Japanese Laid-Open Patent Application No. 2006-146415

### SUMMARY OF THE INVENTION

The embodiments of the present invention are provided in consideration of the above points.

The object of the present invention is to provide an information sharing apparatus, an information sharing system, and a method of processing information.

One aspect of the embodiments of the present invention may be to provide an information sharing apparatus for sharing an operation on contents with another apparatus including a generating part configured to generate a message containing a command corresponding to the operation on the contents; a sending part configured to send the message to a server, which delivers the message to the another apparatus; an interpreting part configured to interpret the message to obtain the command; and an updating part configured to update a display of the contents based on the obtained command.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 is an exemplary structural drawing of an information sharing system of the embodiment;

FIG. 2 is a hardware structural drawing of an exemplary computer of the embodiment;

FIG. 3 is an exemplary structural drawing of an information sharing system using XMPP;

FIG. 4 is an exemplary sequence chart illustrating a flow of process in the information sharing system of the embodiment;

FIG. 5 is an exemplary functional block diagram substantialized by a program run by a JavaScript engine (“JavaScript” is a registered trademark);

FIG. 6 is an explanation drawing for explaining an exemplary XMPP message;

FIG. 7 illustrates an exemplary screen image displayed on a WEB browser;

FIG. 8 is an explanation drawing of three tags for displaying a display column;

FIG. 9 is an explanation drawing for explaining an example of display update in the information sharing system of the embodiment;

FIG. 10 is an exemplary flowchart for illustrating a presence procedure for being present at a room; and

FIG. 11 is an exemplary structural view of an information sharing system using XMPP.

### DETAILED DESCRIPTION OF THE PREFERRED EMBODIMENTS

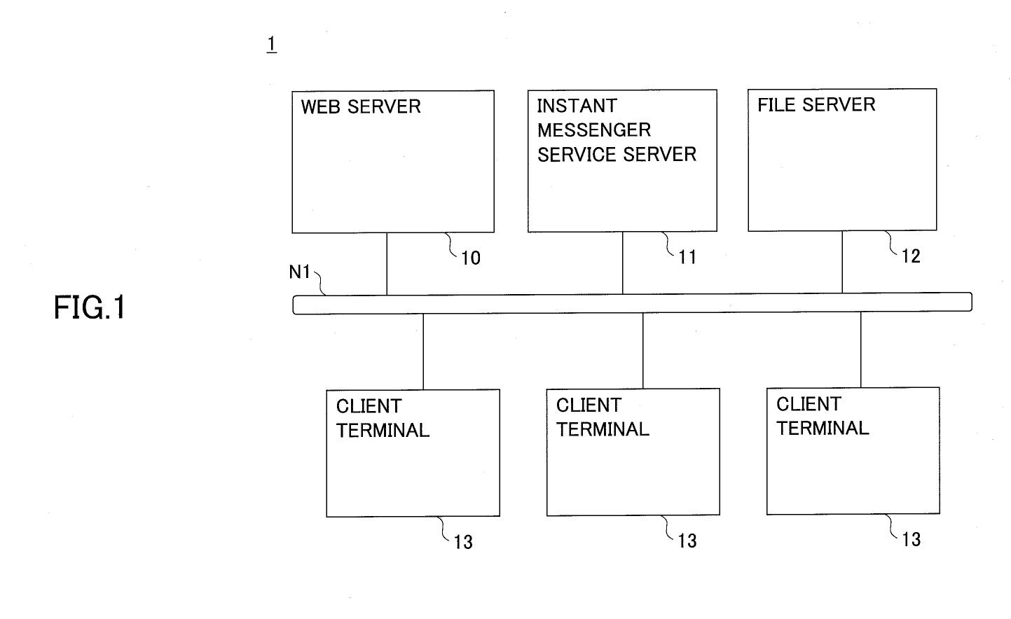

A description is given below, with reference to FIG. 1 through FIG. 11 of embodiments of the present invention. Where the same reference symbols are attached to the same parts, repeated description of the parts is omitted.

Reference symbols typically designate as follows:
1, 1A, 1B: information sharing system;
10: WEB server;
11: instant messenger service server;
12: file server;
13, 14: client terminal;
16: XMPP server;
17: Connection Manager (CM);
21: WEB browser;
22: conference application software;
31: HTML engine;
32: JavaScript engine (“JavaScript” is the registered trademark);
51: DOM updating portion;
52: XMPP sending and receiving portion;
53: canvas depicting portion;
54: InkML generator portion;
55: InkML parser portion;
100: computer;
   101: input device;
102: output device;
103: external I/F;
103a: recording medium;
104: Random Access Memory (RAM);
105: Read Only Memory (ROM);
106: Central Processing Unit (CPU);
107: communication I/F;
108: Hard Disk Drive(HDD); and
N1: network.

### First Embodiment

### System Structure

FIG. 1 is an exemplary structure of an information processing system of the first embodiment. Referring to FIG. 1, in an exemplary structure of the information sharing system 1, a WEB server 10, an instant messenger service server 11, a file server 12, and a plurality of client terminals 13 are connected to a network such as a Local Area Network (LAN).

The WEB server 10, the instant messenger service server 11, and the file server 12 may be software or services, which run in different corresponding computers or in a single computer. The WEB server 10, the instant messenger service server 11, and the file server 12 may be in a mode of, for example, a so-called “cloud”.

The WEB server 10 stores information such as an HTML document, a Cascading Style Sheets (CSS) file, a JavaScript file (“JavaScript” is the registered trademark, hereinafter the same), an image file, or the like. The JavaScript file (“JavaScript” is the registered trademark) is an example of a file described by a script language (simplified programming language). The WEB server 10 is software having an information sending function using World Wide Web (WWW). The WEB server 10 may be substantialized by Apache HTTP Server 10, which is free software, Internet Information Services (IIS) produced by Microsoft Corporation, or the like.

The instant messenger service server 11 is software, which provides a service substantializing real-time communication through the network N1. The instant messenger service server 11 may be substantialized by NET Messenger Service produced by Microsoft Corporation, [RFC3920] or [RFC3921] of Extensible Messaging and Presence Protocol (XMPP), or the like.

The file server 12 is software enabling a memory device, which is controlled by the file server, to be shared with another computer in the network N1 so that the memory device can be used from an outside of the file server 12. The file server 12 may be substantialized by File Transfer Protocol (FTP), World Wide Web Distributed Authoring and Versioning (WebDAV), or the like.

The client terminal 13 is an information processing apparatus operated by a user. The client terminal 13 is, for example, a desktop personal computer, a notebook computer, a tablet PC, a smartphone, a mobile phone, a projector, or the like. The client terminal 13 can access the WEB server 10. The WEB server 10 can respond to a request received from the client terminal 13.

(Hardware Structure)

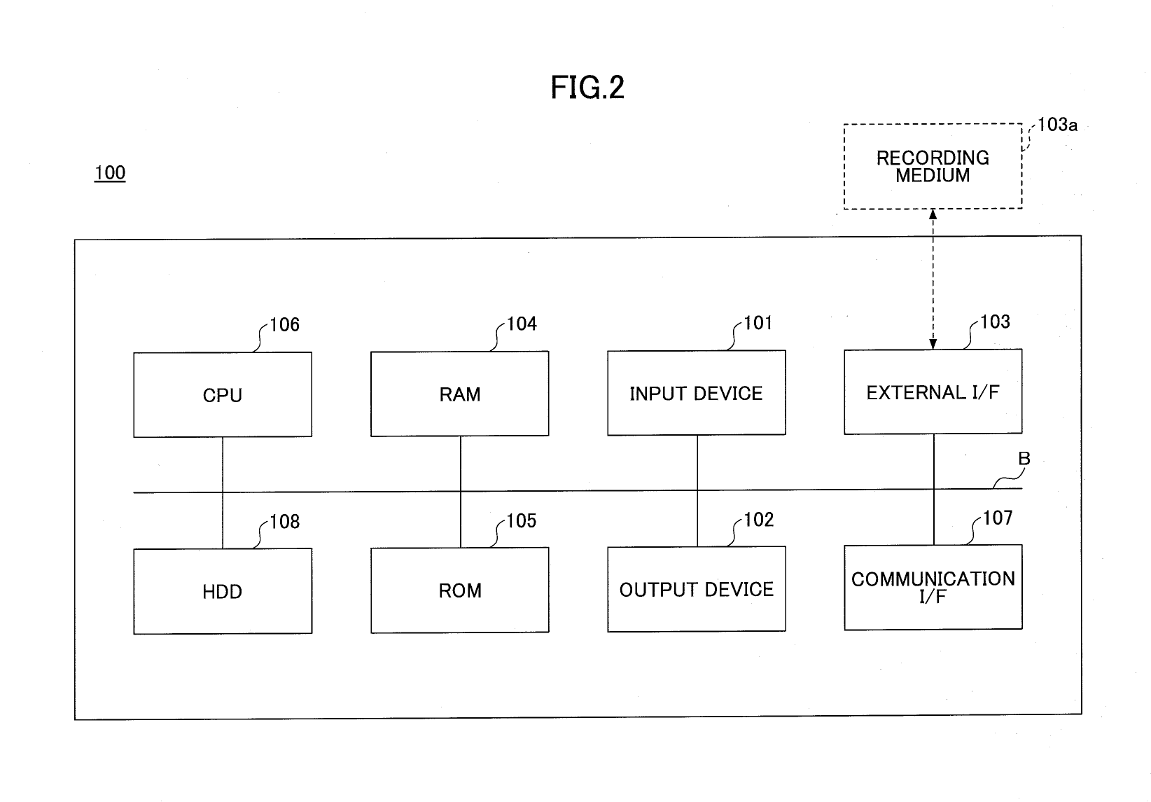

The WEB server 10, the instant messenger service server 11, the file server 12, and the client terminal 13 are substantialized by, for example, a computer 100 having a hardware structure illustrated in FIG. 2.

FIG. 2 is a hardware structural view of an exemplary computer of the first embodiment. Referring to FIG. 2, the information processing apparatus 100 includes an input device 101, a display device 102, an external I/F 103, a random access memory (RAM) 104, a read only memory (ROM) 105, a central processing unit (CPU) 106, a communication I/F 107, and a hard disk drive (HDD) 108, which are mutually connected via a bus B.

The input device 101 may include a keyboard and a mouse, which are used to input various operation signals to the computer 100. The output device 102 includes a display or the like to display a processing result obtained by the computer 100.

The communication I/F 107 is an interface provided to connect the computer 100 with the network N1. Thus, the computer 100 can perform data communication with another computer 100 through the communication I/F 107.

The HDD 108 is a non-volatile memory device storing a program and data. The stored program and data are an operating system (OS), which is basic software controlling the entire information processing apparatus 100, application software providing various functions in the OS, and so on.

Further, the HDD 108 manages the stored program and data using a predetermined file system and/or Data Base (DB).

The external device is a recording medium 103a or the like. With this, the computer 100 can read information from the recording medium 103a and/or write information to the recording medium 103a through the external I/F 103. The recording medium 103a includes a flexible disk, a Compact Disk (CD), a Digital Versatile Disk (DVD), an SD Memory card (SD), a Universal Serial Bus (USB) memory, or the like.

The ROM 105 is a non-volatile semiconductor memory (memory device) which can hold program and/or data even when the ROM 105 is powered off. The ROM 105 stores programs and data such as Basic Input/Output System (BIOS), OS setup, network setup, or the like, which are executed at a time of booting up the computer 100. The RAM 104 is a volatile semiconductor memory (memory device) temporarily storing programs and/or data.

The CPU 106 reads the program or the data from the memory device such as the ROM 105, the HDD 108, or the like. The read program or the read data undergo a process to thereby substantialize a control or a function of the entire information processing apparatus 100.

The WEB server 10, the instant messenger service server 11, the file server 12, and the client terminal 13 perform various processes described below by running a program in the processor 106 or the like of the computer having the above described hardware structure.

### <Detailed Process>

Hereinafter, a detailed process of the information sharing system 1 of the first embodiment is described. Here, described is an exemplary information sharing system 1A in which the instant messenger service server 11 uses XMPP.

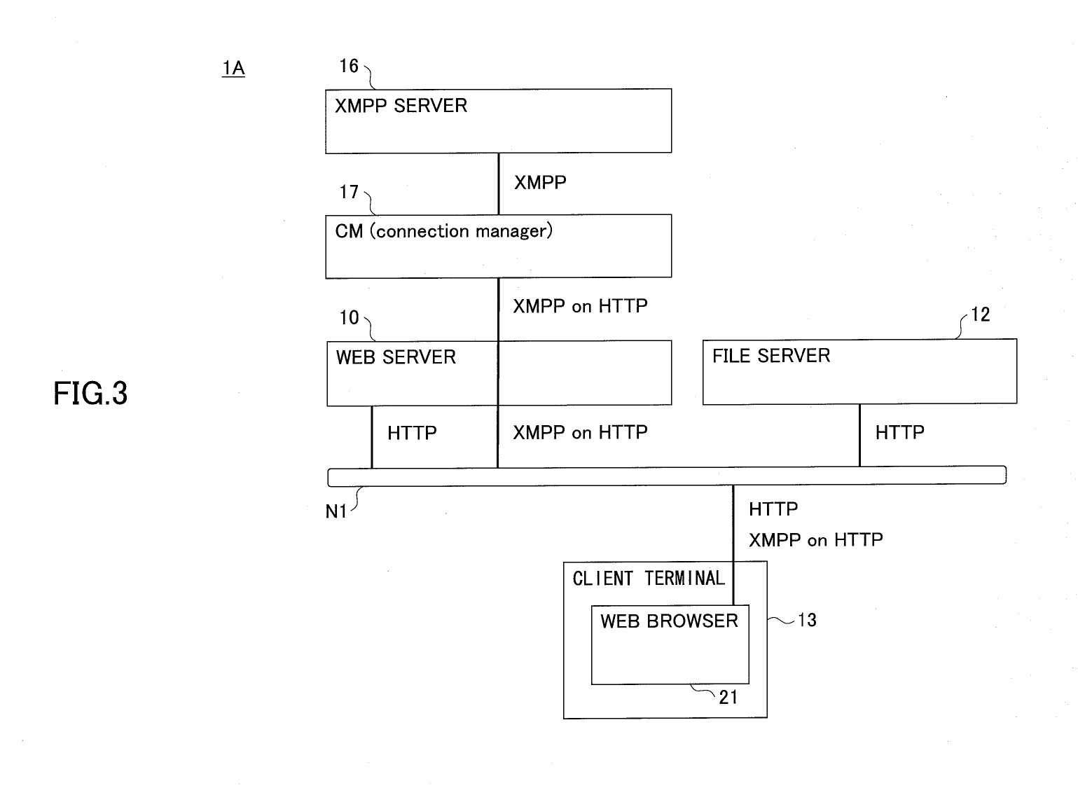

FIG. 3 is an exemplary structural drawing of the information sharing system using XMPP. FIG. 3 illustrates an exemplary structure of the information sharing system 1A where the WEB server 10, the file server 12, the client terminal 13, an XMPP server 16, and a Connection Manager (CM) are connected to the network N1. The XMPP server 16 is an example of the instant messenger service server 11.

XMPP is standardized in IETF as RFC3920(Extensible Messaging and Presence Protocol: Core), and RFC3921(Extensible Messaging and Presence Protocol: Instant Messaging and Presence). Extended specifications are documented as XEP.

XMPP can provide a service called “group chat (Multi-User Chat [XEP-0045])”. The group chat is a function of delivering a message, which is sent by a client terminal 13 being present at a room provided by XMPP to the XMPP server 16, to all client terminals 13 being present at the room.

In the XMPP, there is a technique called a Bidirectional-streams Over Synchronous HTTP (BOSH) for sending and receiving messages of HTTP. By using BOSH, the XMPP server 16 performs XMPP communication using HTTP. Further, the XMPP server 16 provides a function of asynchronously causing the XMPP server 16 to send information to the client terminal 13 (the XMPP server 16 does not send the information upon a request from the client terminal 13) and causing the client terminal 13 to receive information. Hereinafter, the XMPP communication using HTTP is referred to as XMPP on HTTP. Practically, XMPP sends and receives Extensible Markup Language (XML) data. In XMPP on HTTP, XML data of XMPP is received using HTTP.

In BOSH, a connection manager (CM) 17 is introduced as a special proxy. The CM 17 exchanges ordinary XML data of XMPP with the XMPP server 16. Further, the CM 17 exchanges XML data of XMPP, which is wrapped, with the WEB server 10, which is an HTTP client, using HTTP.

The WEB server 10 stores an HTML file (an HTML document) to be displayed by a WEB browser 21 installed in the client terminal 13, a CSS file associated with the HTML file, a JavaScript file, an image file, or the like. A Uniform Resource Locator (URL) is used to designate the WEB server 10 and the HTML file from the WEB browser 21.

Further, the information sharing system 1A operates a Document Object Model (DOM) by using a technique of (Asynchronous Javascript XML (Ajax)) to rewrite a content displayed by the WEB browser 21. The technique of Ajax is a mode of proceeding a process by exchanging the XML data without reloading the Web page in use of an HTTP communication function of the JavaScript file.

The method of rewriting the content displayed by the Web browser 21 is not limited to a method of updating the DOM. For example, in “HTML5”, it is possible to directly rewrite the content displayed by the Web browser 21.

For example, in the information sharing system 1A, XML data are generated using JavaScript in response to a selection of data displayed by the WEB browser 21 or a user's input (a user's operation) of a display page of the data to be displayed, a text, a graphic, a handwritten memo, and so on. The generated XML data are sent to the XMPP server 16 using XMPP on HTTP through a group chat.

The XMPP server 16 delivers the XML data to all the client terminals 13 being present at the room using XMPP on HTTP. The client terminal 13 receiving the XML data through the group chat interprets the XML data using JavaScript and operates (updates) DOM. Thus, the data to be displayed, the display page of the data to be displayed, display of the text, the graphic, the handwritten memo or the like is updated.

The data to be displayed are previously stored in the file server 12. The file server 12 provides an access using HTTP so as to be read by the WEB browser 21. The file server 12 may be the same as the WEB server 10 illustrated in FIG. 3, another WEB server, or a WebDAV server.

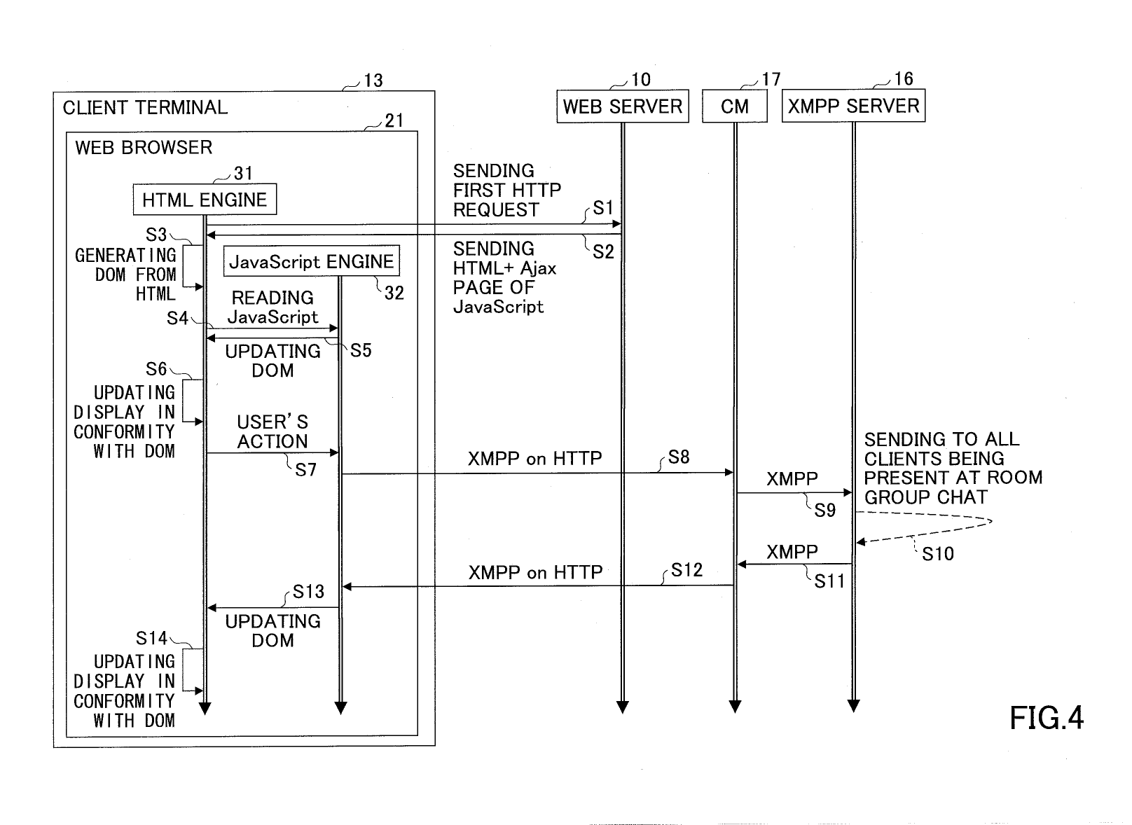

FIG. 4 is an exemplary sequence chart illustrating a flow of process in the information sharing system of the embodiment. Referring to a sequence chart illustrated in FIG. 4, a specific XMPP message and a dynamic display update by Ajax are described.

In step S1, a user designates the URL in the WEB browser 21 of the client terminal 13. The URL designated by the user is provided to designate the WEB server 10 and an HTML file. An HTML engine 31 of the WEB browser 21 sends a first HTTP request to the URL designated by the user.

In step S2, the WEB server 10 returns the HTML file corresponding to the URL of the HTTP request and an Ajax page including a JavaScript file, an image file, and so on, which are associated with the HTML file, to the HTML engine 31 of the WEB browser 21 as an HTTP response.

In step S3, the HTML engine 31 generates DOM from the received HTML file, and performs a screen display based on the DOM. In step S4, the HTML engine 31 sends the received JavaScript file to a JavaScript engine 32 of the WEB browser 21. The JavaScript engine 32 reads the received Java script file.

In step S5, the JavaScript engine 32 updates DOM if necessary. In step S6, the HTML engine 31 updates the screen display in response to the update of DOM.

Thereafter, the user continues to explain on the WEB browser 21 after an action such as designation of a conference material, designation of a display page, or depicting of a handwritten memo is performed. In step S7, the HTML engine 31 of the WEB browser 21 reports a user's action to the JavaScript engine 32.

In step S8, the JavaScript engine 32 generates an XMPP message corresponding to the user's action, and sends the generated XMPP message to the CM 17 through the group chat using XMPP on HTTP.

Meanwhile, XMPP on HTTP is performed through the WEB server 10. The CM 17 performs a conversion from XMPP on HTTP to an XMPP message, which can be interpreted by the XMPP server 16. This conversion from XMPP on HTTP to the XMPP message performed by the CM 17 is a prescribed operation of BOSH.

In step S9, the CM 17 sends the converted XMPP message to the XMPP server 16. In step S10 to S12, when the XMPP server 16 receives the XMPP message through the group chat, the XMPP server 16 sends the XMPP message via the CM 17 and the WEB server 17 and the WEB server 10 to all the client terminals 13 being present at a room for the group chat.

The CM 17 converts the XMPP message to XMPP on HTTP, and sends the XMPP message through the WEB server 10 to the JavaScript engine 32 through the WEB server 10 by a Push function. In step S13, the JavaScript engine reads the received XMPP message and updates DOM in conformity with the XMPP message. In step S14, the HTML engine 31 updates the screen display in conformity with the update of DOM.

The connection with the XMPP server 16 is started after Stream is opened and authentication is done. However, because the connection follows the specifications of XMPP, an explanation of the connection is omitted.

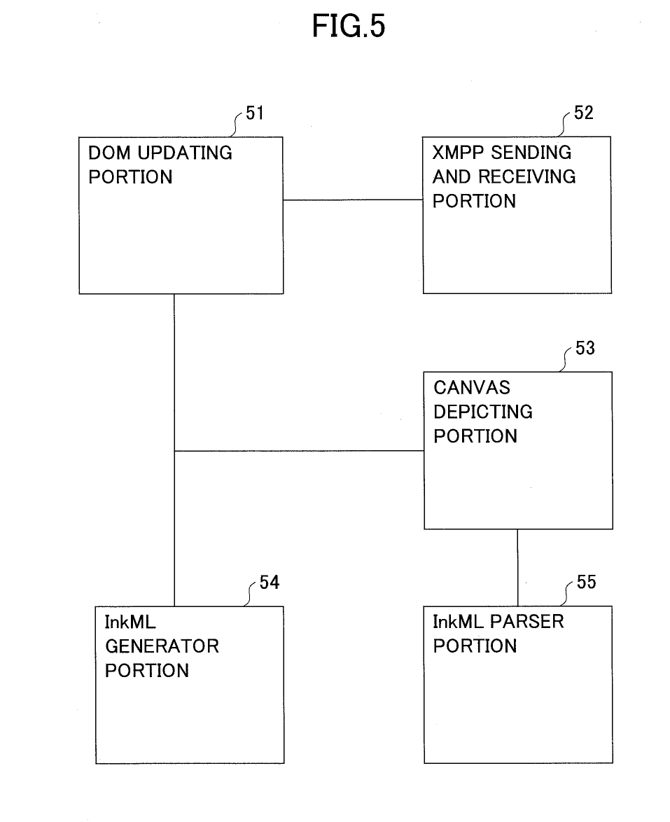

FIG. 5 is an exemplary functional block diagram substantialized by a program run by a JavaScript engine (“JavaScript” is the registered trademark). The program executed by the JavaScript engine 32 corresponds to the JavaScript file read in step S4. The JavaScript engine 32 substantializes a DOM updating portion 51, an XMPP sending and receiving portion 52, a canvas depicting portion 53, an InkML generator portion 54, and an InkML parser portion 55.

The DOM updating portion 51 has a function of updating a DOM structure of the HTML file and a function of processing an event in the WEB browser 21. The DOM updating portion 51 properly updates the DOM structure in response to a command in the XMPP message or an event occurring in the WEB browser 21 and reflects the updated DOM structure on a display on the WEB browser 21. It is a standardized function of the WEB browser to reflect the updated DOM on the display of the WEB browser after updating the DOM.

The function of updating the DOM structure or the function of processing the event occurring in the WEB browser can be easily substantialized by using, for example, jQuery. The jQuery is an open source JavaScript library, which had been released in January 2006 at BarCamp NYC by John Resig.

The XMPP sending and receiving portion 52 generates an XMPP message, and sends the XMPP message using XMPP on HTTP. Further, the XMPP sending and receiving portion 52 receives the XMPP message using XMPP on HTTP. When the XMPP sending and receiving portion 52 receives the XMPP message, the XMPP sending and receiving portion 52 analyzes the XMPP message and updates the DOM structure of the HTML file with the DOM updating portion 51.

The canvas depicting portion 53 is a part of depicting a graphic of Scalable Vector Graphics (SVG) data on a canvas tag (described below) using JavaScript or a part of depicting a trace of InkML (described below). The canvas depicting portion 53 passes InkML data to the InkML parser portion 55 for depicting InkML. The InkML parser portion 55 converts the passed InkML data to a data structure, which can be interpreted by the canvas depicting portion 53 and returns the converted InkML data to the canvas depicting portion 53.

Further, when the user instructs a depiction of a graphic in the WEB browser 21, the DOM updating portion 51 catches an event corresponding to the instruction. The canvas depicting portion 53 depicts on “canvas” in conformity with the event and generates SVG data using a toDataURL command of “canvas”. The XMPP sending and receiving portion 52 sends the generated SVG data as a graphic adding message. When a deletion of the graphic is instructed, the XMPP sending and receiving portion 52 sends a graphic deleting message.

Similarly, when the user instruct a depiction of a handwritten memo on the WEB browser, the DOM updating portion 51 catches an event corresponding to this instruction. The canvas depicting portion 53 depicts in response to the event. The canvas depicting portion 53 causes the InkML generator portion 53 to generate the InkML data after the canvas depicting portion 53 sends coordinate data or the like to the InkML generator portion 54. The XMPP sending and receiving portion 52 sends the generated InkML data as a handwritten memo updating message of the XMPP message.

If it is unnecessary to depict the handwritten memo (described later), the InkML generator portion 54 and the InkML parser portion 55 become unnecessary. Further, if it is unnecessary to depict the handwritten memo (described later), and it is unnecessary to depict the graphic, the canvas depicting portion 53, the InkML generator portion 54, and the InkML parser portion 55 become unnecessary.

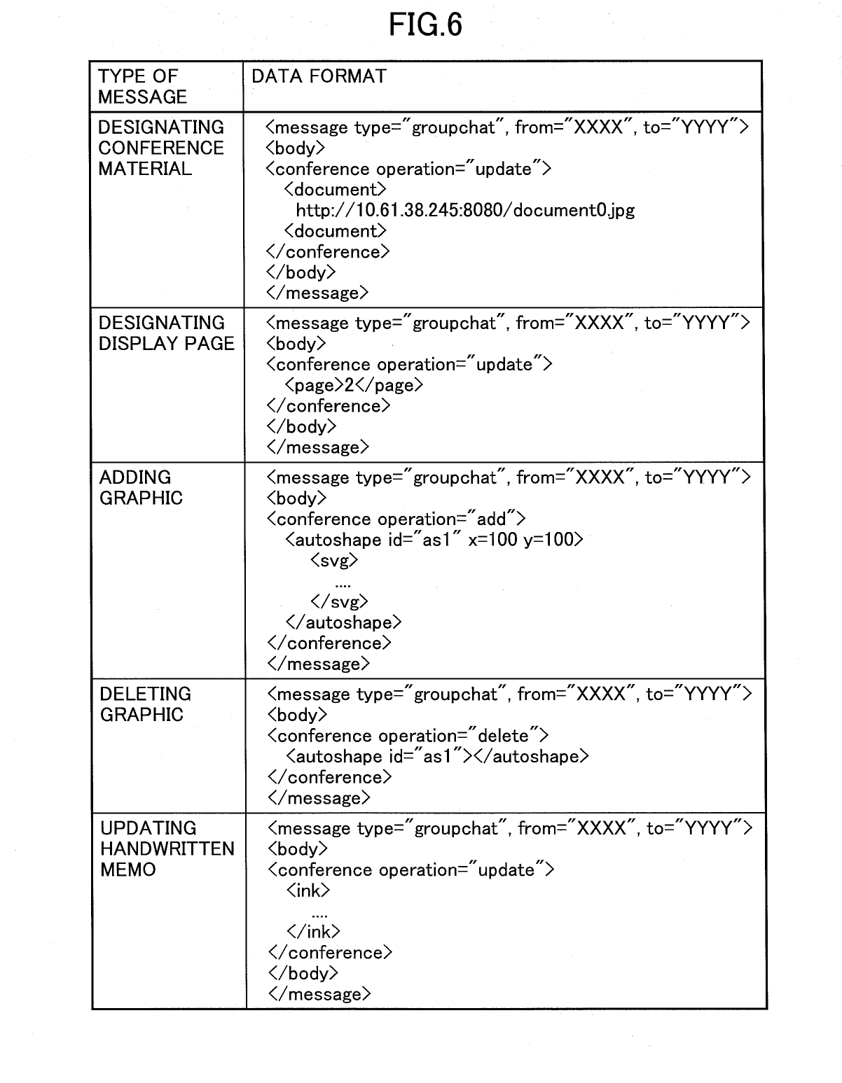

FIG. 6 is an explanation drawing for explaining an exemplary XMPP message. Referring to FIG. 6, data formats of a conference material designating message, a display page designating message, a graphic adding message, a graphic deleting message, and a handwritten memo updating message are illustrated as the exemplary XMPP message.

The group chat using XMPP is performed in a unit of “room”. When the XMPP message is sent through the group chat, “groupchat” is designated in an attribute “type” of a tag “message”. A sender is designated in an attribute “from”. The “room” is designated in an attribute “to”. The content of the message is designated in an attribute “body”.
<message from=“alice@wonderland.lit/rabithole” to =“teaparty@conference.wonderland.lit” type=“groupchat”>
   <body>March Hare: There's PLENTY of rooms!</body></message>

When the sender is present at the room, the sender is designated in the attribute “from” of a tag “presence”. The “room” is designated in the attribute “to”. Because the tag “message” and the tag “presence” are standardized specifications, a detailed explanation is omitted.

<presence from=“alice@wonderland.lit/rabbithole” to =“teaparty@conference.wonderland.lit/Alice”/></presence>

Within the information sharing system 1A of the first embodiment, in order to synchronize displays of the conference material, the graphic, the handwritten memo, and so on among the client terminals 13, the XML data defined in the information sharing system 1A are embedded in a tag “body” of the XMPP message.

A root element that is the uppermost element of these XML data has a tag “conference”. Values such as “update” for updating, “add” for adding, “delete” for deleting, and so on are designated in an attribute “operation” that is provided to add additional information to the root element in the XML data.

In order to share a material used in the conference (the conference material) with the client terminals 13, a conference material designating message has a URL, in which the conference material is stored. The URL is designated by a tag “document”. When the conference material has a plurality of pages, the display page designating message designates display pages in a tag “page” in order to share the display pages with the client terminals.

The graphic adding message designates the graphic data in a tag “autoshape” in order to share the graphic added in one of the client terminals 13 with the client terminals 13. An identifier of the graphic is indicated in an attribute “id” of a tag “autoshape”. An attribute “x” and an attribute “y” designate ordinate and abscissa such as an upper left position of the graphic. The content of the tag “autoshape2 is to define the graphic using SVG data.

SVG is a vector graphics language described using XML and is recommended as open standard in World Wide Web Consortium (W3C). When the graphic is newly added, the value of the attribute “operation” is designated by “add” to define the graphic using the tag “autoshape” and the SVG data. Exemplary SVG data are as follows.

```
<svg width=“5cm” height=“4cm” version=“1.1”
      xmlns=“http://www.w3.org/2000/svg”>
  <desc>Four separate rectangles</desc>
    <rect x=“0.5cm” y=“0.5cm” width=“2cm”
height=“1cm”/>
    <rect x=“0.5cm” y=“2cm” width=“1cm”
height=“1.5cm”/>
    <rect x=“3cm” y=“0.5cm” width=“1.5cm”
height=“2cm”/>
    <rect x=“3.5cm” y=“3cm” width=“1cm”
height=“0.5cm”/>
  <rect x=“.01cm” y=“.01cm” width=“4.98cm”
height=“3.98cm”
      fill=“none” stroke=“blue”
stroke-width=“.02cm” />
</svg>
```

The graphic deleting message is provided to delete the graphic. In the graphic deleting message, the value of the attribute “operation” is designated as “delete”, and the tag “autoshape” to be deleted is designated. At this time, the object to be deleted is distinguished by the attribute “id” of the tag “autoshape”.

Further, the handwritten memo updating message designates the handwritten memo data in a tag “ink” so that the handwritten memo added by one of the clients terminals 13 is shared with the client terminals 13. The format of the tag “ink” is defined by InkML. InkML is provided to describe the handwritten data using XML data. Recommended specifications of InkML is recommended by W3C. Exemplary InkML data are as follows.

```
<ink xmlns=“http://www.w3.org/2003/InkML”
documentID=“abcdefg123”>
  <definitions>
    <brush xml:id=“br1”>
      <brushProperty name=“color” value=“#000000”/>
      <brushProperty name=“width” value=“6”
units=“dev”/>
    </brush>
    <brush xml:id=“br2”>
      <brushProperty name=“color” value=“#FF0000”/>
      <brushProperty name=“width” value=“20”
units=“dev”/>
    </brush>
  </definitions>
  <trace brushRef=“#br1” xml:id=“tr1”>90 89, 91 90,
93 95, 97 101, 103 110, 111 120, 119 129</trace>
  <trace brushRef=“#br2” xml:id=“tr2”>234 365, 236
363, 239 359, 242 357, 245 354, 249 351</trace>
</ink>
```

The handwritten memo added to the conference material is expressed by a piece of InkML data. When the handwritten memo is updated, the value of the attribute “operation” is designated as “update”.

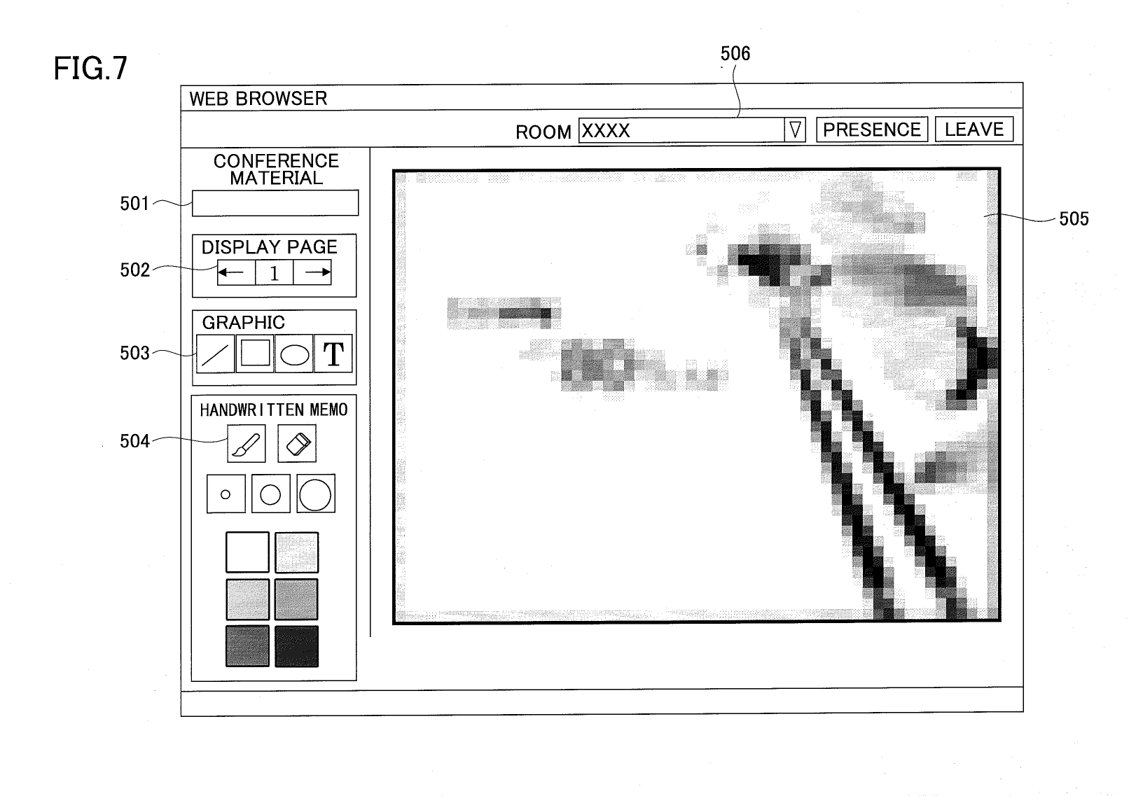

FIG. 7 illustrates an exemplary screen image displayed on a WEB browser. The GUI of the information sharing system 1A in the client terminal 13 is substantialized by the screen rendered by the WEB browser 21 as illustrated in FIG. 7. The rendering by the WEB browser 21 is dynamically updated using the above-described technique of Ajax.

A pull-down menu 506 is provided to select a room, at which the participant (the client terminal 13) is present. A presence button and a leave button positioned on the right side of the pull-down menu 506 are provided to be present at and leave the room provided by XMPP.

When the HTML file is loaded, the WEB browser 21 performs an Anonymous login in conformity with the specifications of XMPP to obtain a list of rooms. The WEB browser 21 sets the obtained list of the rooms as a dropdown list to be displayed on the pull-down menu 506.

The user selects a favorite room from the drop-down list of the pull-down menu 506, and pushes the presence button. When the presence button is pushed down, the WEB browser 21 sends the above-described XMPP message indicating that the user is present at the selected room. The XMPP message indicating that the user is present at the selected room has standardize specifications. Further, the user can leave the room while the user is present at the room by pushing down the leave button. When the leave button is pushed, the WEB browser 21 sends the XMPP message indicating that the user leaves the room, at which the user is present. The XMPP message indicating that the user leaves from the selected room has standardized specifications.

A URL designating the location of the conference material is input into an input column 501. The WEB browser 21 generates the above-described XMPP message designating the conference material from the URL input into the input column 501 and sends this XMPP message. The WEB browser 21 obtains an HTML file or the like from the URL input into the input column 501 and displays the obtained HTML file on a display column 505.

A selection column is provided to select a display page of the conference material to be displayed. For example, when the right arrow button in the selection column 502 is pushed down by the user, the WEB browser 21 displays the next page of the conference material: For example, when the left arrow button in the selection column 502 is pushed down by the user, the WEB browser 21 displays the previous page of the conference material. Further, the WEB browser 21 generates the above-described XMPP message of the display page designating message and sends the thus generated XMPP message.

A selection column 503 is provided to select a graphic to be added. For example, the user may push down the button corresponding to a graphic to be added in the selection column 503 and may instruct a starting point, an ending point, and so on by clicking on a button of a mouse or by touching a screen panel to input in the display column 505. As a result, the graphic can be displayed in the display column. The selection column 503 includes buttons corresponding to a straight line, a rectangle, an ellipse, and a text as examples of the graphic to be added. Methods of instructing the starting point, the ending point, and so on differ depending on a device used to input in the display column 505 by the user. For example, a mouse is used for a personal computer (PC). A touch on a screen can be used in a tablet PC.

In the WEB browser 21, when the button corresponding to the text is pushed as the example of the graphic to be added, the user may select an area of the display column 505 and may input the text in the area. The WEB browser 21 generates SVG data from a user's operation of adding the graphic by JavaScript. Further, the WEB browser 21 generates the above-described XMPP message of the graphic adding message and sends the thus generated XMPP message.

When the graphic additionally displayed in the display column 505 is deleted, the user can display a menu for editing the graphic by a long touch on the graphic, a right click on the graphic or the like. The user can delete the graphic from the display column 505 by selecting a deletion on the displayed menu. When the long touch on the graphic, the right click on the graphic or the like is conducted by the user, the WEB browser causes the menu to be displayed on the display column 505.

When the user selects the deletion on the menu, the WEB browser 21 deletes the graphic, which is provided with the long touch, the right click or the like, from the display column 505. Further, the WEB browser 21 generates the above-described XMPP message of the graphic deleting message and sends the thus generated XMPP message.

A selection column 504 is provided to add or delete a handwritten memo. For example, the user may push down buttons corresponding to a brush, an eraser, a brush size, a brush color, and so on in the selection column 504 in order to select the brush, the eraser, the brush size, the brush color, and so on. For example, the selection column 504 includes two buttons corresponding to a brush and an eraser in the upper stage, three buttons corresponding to brush sizes in the middle stage, and six buttons corresponding to brush colors in the lower stage.

When the user depicts a trace in the display column 505, the user pushes the buttons corresponding to the brush, the brush size, and the brush color. Then, the user pushes the button of the mouse or touches the screen to designate a position in the display column 505. While maintaining pushing the button of the mouse or touching the screen, the designated position is moved. Then, the button is released from pushing or the screen is released from touching the screen. During the movement of the mouse or the touch, a trajectory is recorded using coordinates picked up at a sampling interval. The trace depicted in the display column 505 is formed by connecting the coordinates with straight lines.

The WEB browser 21 records coordinates of a trajectory handwritten by the user at a sampling interval and connects the coordinates with straight lines. Thus, the trace of the handwritten memo can be depicted. Further, the WEB browser 21 generates InkML data of the handwritten memo using JavaScript, generates the above-described XMPP message of the handwritten memo updating message, and sends the thus generated XMPP message.

Further, after the user pushes the button corresponding to the eraser in the selection column 504, the user can delete the trace by sliding the eraser across the trace of the handwritten memo in the display column 505.

The WEB browser 21 deletes the trace in the display column 505 by the operation of the user of sliding the eraser across the trace of the handwritten memo in the display column 505. Further, the WEB browser 21 deletes the corresponding trace from InkML data of the handwritten memo using JavaScript, generates the above-described XMPP message of the handwritten memo updating message, and sends thus generated XMPP message.

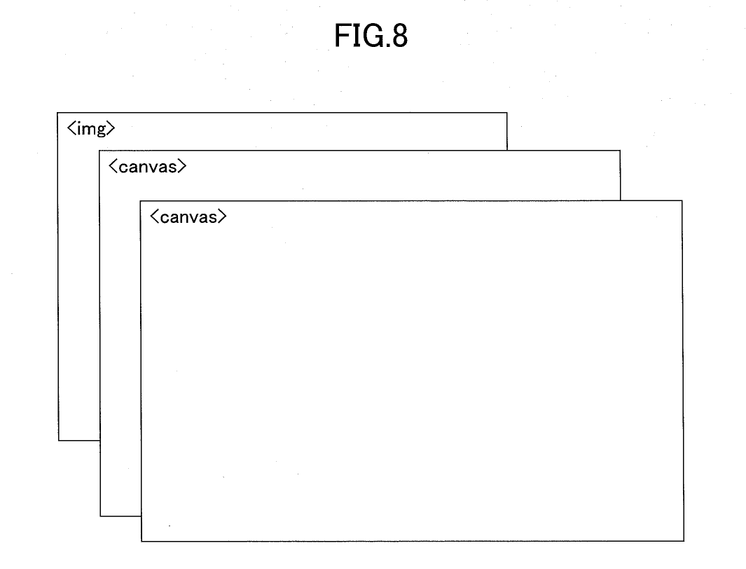

In the HTML file, the display column 505 is substantialized by three tags as illustrated in FIG. 8. FIG. 8 is an explanation drawing of the three tags for substantializing the display column. The three tags can be substantialized by using, for example, “canvas” of “HTML5”. The draft of “HTML5” had been presented in 2008 by W3C. The WEB browser 21 may support “HTML5”. For example, the three tags may be substantialized by “Flash Player” (“Flash Player” is a registered trademark of Adobe).

The three tags are Cascading Style Sheets (CSS) having the same size. The three tags are arranged so as to overlap. The first (lowermost) tag “img” displays an image of the conference material. The second tag “canvas” is provided to depict a graphic. The third tag “canvas” is provided to depict the handwritten memo.

Because the graphic can be depicted in the tag “canvas” of “HTML5” using JavaScript, the tag “canvas” can easily substantialize the handwritten memo as the trajectory of the graphic using a mouse event or a touch event of JavaScript. A graphic such as a straight line, a rectangle, or an ellipse can be depicted in the tag “canvas” of “HTML5”. The depicted graphic can be changed to SVG data using toDataURL command. The three tags overlap to substantialize the display column 505 because depictions with functions can be prevented from interfering in designing the display column 505.

When the XMPP message is received through a group chat, the WEB browser analyzes the XMPP message. When the XMPP message is the conference material designating message, the WEB browser 21 downloads the conference material and displays the image of the first page of the conference material in the first (lowermost) tag “img”.

When the XMPP message is the display page designating message, the WEB browser 21 displays the designated display page in the first (lowermost) tag “img”. When the XMPP message is the graphic adding message, the WEB browser 21 depicts the graphic defined by the SVG data in the second tag “canvas”. Further, when the XMPP message is the graphic deleting message, the WEB browser 21 deletes the graphic, which has an attribute “id” to be deleted, from the second tag “canvas”. Further, when the XMPP message is the handwritten memo updating message, the WEB browser 21 depicts the trace in the third tag “canvas” in conformity with the InkML data.

Within the first embodiment, the user who is allowed to designate the conference material, to select the page, to add or delete the graphic, or to update the handwritten memo is not limited. However, it is possible to give authority of designating the conference material, selecting the page, adding or deleting the graphic, or updating the handwritten memo to users.

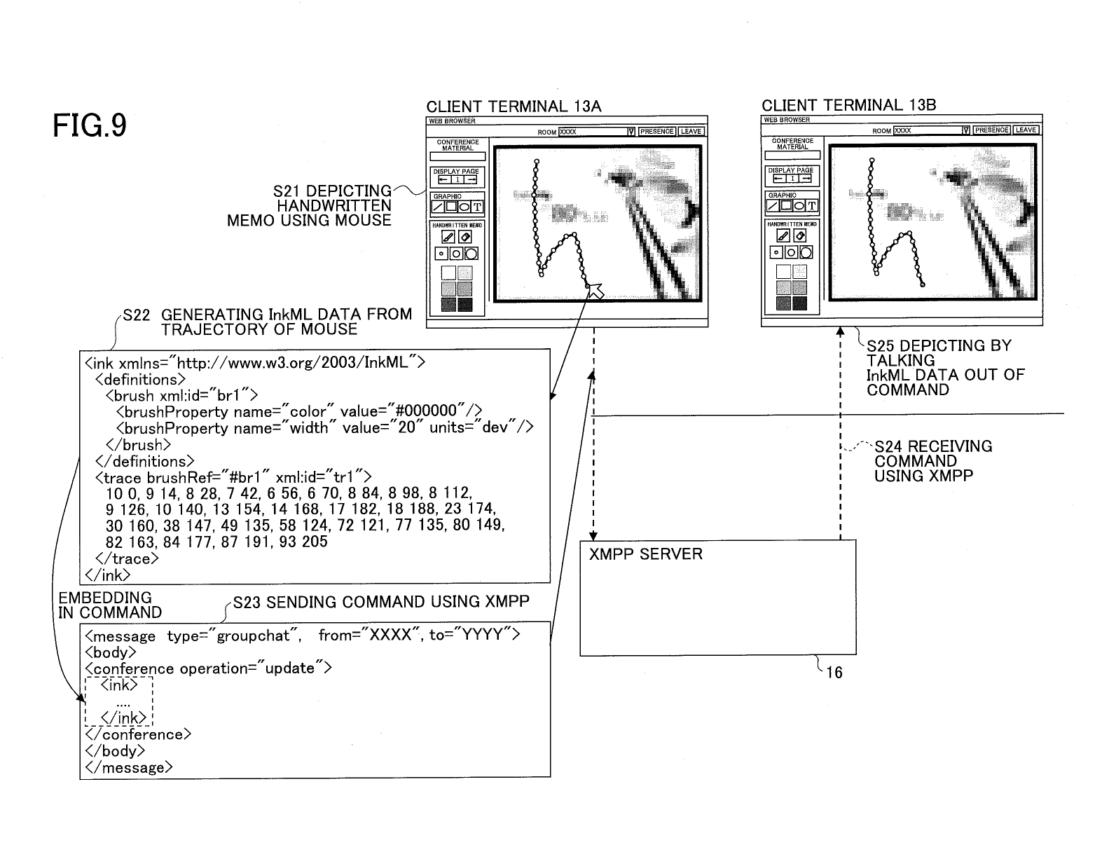

Further, FIG. 9 illustrates a flow of updating a display on another client terminal 13B is updated when a handwritten memo is depicted in the client terminal 13A. FIG. 9 is an explanation drawing for explaining an example of display update in the information sharing system of the first embodiment.

In step S21, the user depicts the handwritten memo by depicting a trace on the screen of the client terminal 13A as illustrated in FIG. 7 with the mouse. The WEB browser 21 of the client terminal 13A records coordinates of a trajectory handwritten by the user at a sampling interval and connects the coordinates with straight lines. Thus, the trace of the handwritten memo can be depicted.

In step S22, the WEB browser 21 generates the InkML data of the handwritten memo from the coordinates of the trajectory of the mouse using JavaScript. In step S23, the WEB browser 23 embeds the InkML data generated in step S22 in the XMPP message, and sends the XMPP message to the XMPP server through a group chat.

In step S24, the XMPP message is delivered to the client terminal 13B, which is present at the room for the group chat after the XMPP message is received by the XMPP server 16. In step S25, the WEB browser 21 of the client terminal 13B takes the InkML data embedded in the XMPP message out of the XMPP message. The WEB browser 21 depicts a trace similar to the trace depicted on the client terminal 13A with the mouse in conformity with the taken InkML data.

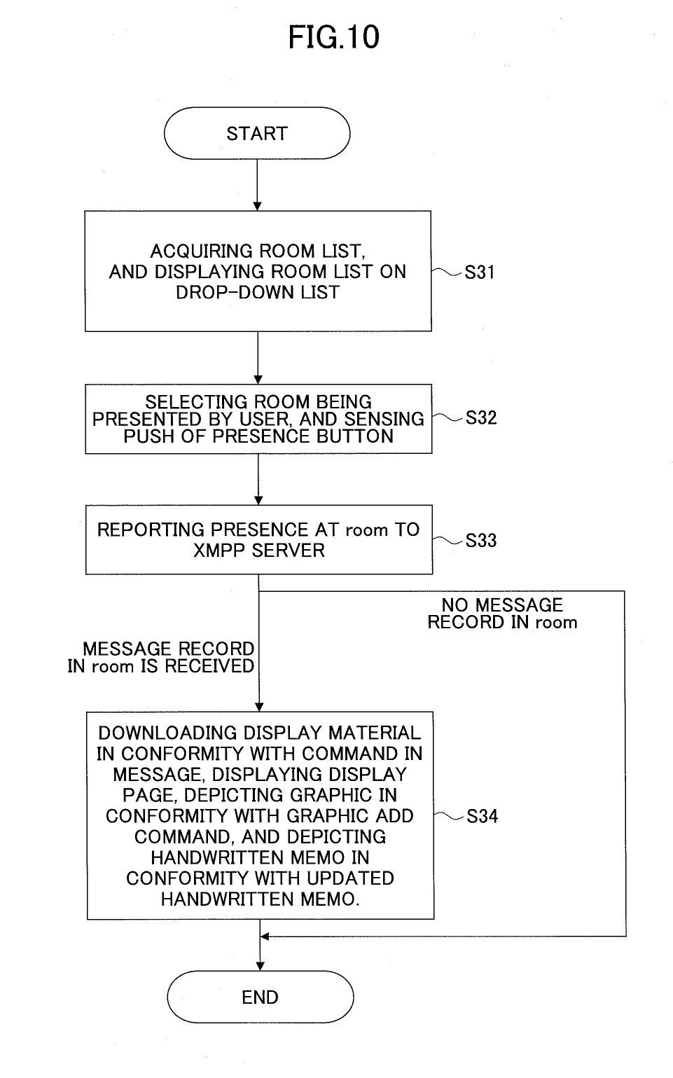

FIG. 10 is an exemplary flowchart for illustrating a presence procedure for being present at the room. In step S31, the WEB browser 21 performs the Anonymous login in conformity with the specifications of XMPP to obtain the list of the rooms as described above. The WEB browser 21 sets the obtained list of the rooms as the dropdown list to be displayed on the pull-down menu 506. The user operates the pull-down menu 506 to cause the drop-down list to be displayed.

In step S32, the user selects the favorite room from the drop-down list of the pull-down menu 506, and pushes the presence button. The WEB browser 21 senses a push of the presence button by the user for selecting the room from the drop-down list with reference to an event of JavaScript.

In step S33, the WEB browser 21 sends the above-described XMPP message, which indicates that the user will be present at the room selected by the user, to the XMPP server 16. Although the example that the rooms are prepared is described, a function of generating (adding) a new room may be added. The function of generating the new room can be easily substantialized because the function of generating the new room is defined by the standard specifications of the XMPP.

According to the specifications of XMPP, when a client terminal is present at a room, an available message record is sent to the client terminal. If the client terminals send no XMPP message in the room, the message record is not sent. Therefore, the process of the flowchart illustrated in FIG. 10 ends. In step S34, when the message record is sent, the WEB browser 21 analyzes the XMPP messages sent in the room by that time.

For example, the WEB browser 21 downloads the conference material in conformity with the conference material designating message, displays the page of the conference material in conformity with the display page designating message, depicts the graph in conformity with the graphic adding message, and depicts the handwritten memo in conformity with the handwritten memo updating message.

### <General Overview>

The information sharing system 1A enables an information exchange between client terminals 13 through a general-purpose WEB browser 21 using a general-purpose instant messenger service and a communication protocol of HTTP. The information exchange between the WEB browsers 21 and the depiction on the screen in response to the information exchange are substantialized by the technique of Ajax.

In the information sharing system 1A, the system of the server uses XMPP, which is an example of the general-purpose instant messenger service. Further, in the information sharing system 1A, the general-purpose WEB browser 21 can be used as the client system.

For example, as a paperless conference system, client terminals of a presenter and a participant share a conference material. When the pages of the conference material are turned over, the pages of the conference material may be synchronously updated on the screen of the client terminal of the participant. In this system, a graphic and a handwritten content depicted on the screen of the client terminal of the presenter by the presenter may be simultaneously displayed on the client terminal of the participant.

However, in this case, dedicated software may be installed in the server and/or the clients. Therefore, in the above case, the cost for developing the server system and the client systems may become high.

In the information sharing system 1, the general-purpose instant messenger service (protocol) and HTTP protocol is used to send or receive the general-purpose instant messenger service, and the technique of Ajax is used in the client terminals 13. With this, the general-purpose WEB browser 21 can be used as the system for the client terminal 13. Further, the server system can be substantialized by the general-purpose WEB server 10 and the instant messenger service server 11. Therefore, a system using the general-purpose program can be substantialized.

### Second Embodiment

Within the first embodiment, the information sharing system 1 is substantialized using the WEB browser installed in the client terminal 13. Within the second embodiment, dedicated application software is installed in apart of the client terminal 13 to cause the dedicated application software to directly communicate with the XMPP server 16 using the XMPP message.

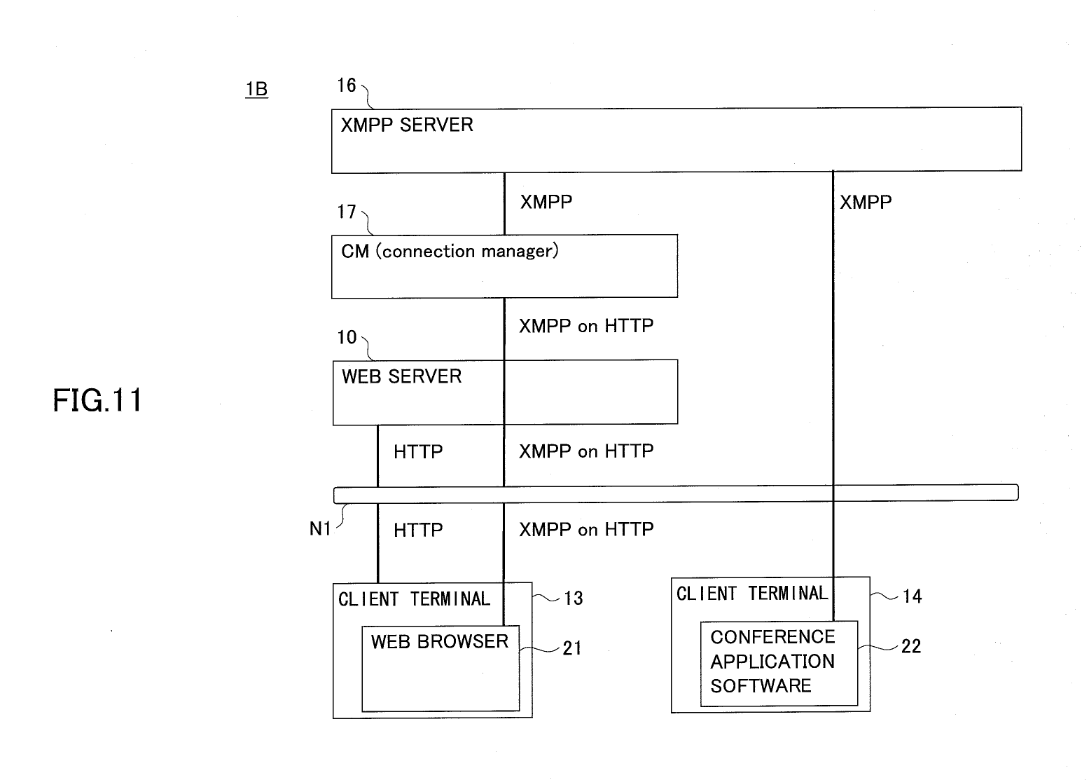

FIG. 11 is an exemplary structural drawing of the information sharing system using XMPP. An information sharing system 1B illustrated in FIG. 11 includes a client terminal 13 being present at a room using the WEB browser 21 and a client terminal 14 being present at a room using conference application software 22 as an example of the dedicated application software.

In the information sharing system 1B, the client terminal 14 is allowed to be present at the room using the conference application software 22. Therefore, in the client terminal 14 having a small screen size such as a tablet PC or a smart phone, a user interface (UI) can be freely designed to enable the screen to be widely used.

For example, in the client terminal 14 having a small screen size such as a tablet PC or a smartphone, there may be a demerit that a part of the screen effectively used becomes further small when the client terminal 14 is present at a room using the WEB browser. Because the WEB browser 21 has an HTML depicting portion inside the UI, the part of the screen effectively used becomes further small.

Because the second embodiment is the same as the first embodiment except for apart of the second embodiment, explanations on the same portions are omitted.

### <General Overview>

Within the second embodiment, the information sharing system 1B, which includes the client terminal 13 being present at a room using the WEB browser 21 and the client terminal 14 being present at a room using conference application software 22, can be substantialized. For example, in the information sharing system 1B of the second embodiment, the client terminal 13 being preset at the room using the WEB browser 21 and the client terminal 14 being present at the room using the conference application software 22 can be mixed. Therefore, the information sharing system 1B can be transferred to the information sharing system 1A of the first embodiment in a step-wise manner.

As described, within the embodiments, the systems using the general-purpose program can be substantialized.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the information sharing system has been described in detail, it should be understood that various changes, substitutions, and alterations could be made thereto without departing from the spirit and scope of the invention.

This patent application is based on and claims the benefit of priority Japanese Priority Patent Application No. 2012-134205 filed on Jun. 13, 2012, the entire contents of which are hereby incorporated herein by reference.

What is claimed is:

1. An information sharing apparatus for sharing an operation on contents with another apparatus, the information sharing apparatus comprising:
a generating part configured to generate a message containing a command corresponding to the operation on the contents;
a sending part configured to send the message to a server, which delivers the message to the another apparatus;
an interpreting part to interpret the message to obtain the command; and
an updating part to update a display of the contents based on the obtained command.

2. The information sharing apparatus according to claim 1, wherein
the command corresponds to at least one of operations of designating the contents, of designating a display page of the contents, of adding a graphic or a character to the contents, of deleting the graphic or the character from the contents, and of adding handwritten data to the contents.

3. The information sharing apparatus according to claim 2, wherein
the generating part generates the message, which can be interpreted by the another apparatus and contains the command corresponding to the operation on the contents.

4. The information sharing apparatus according to claim 3, wherein
the updating part updates a data structure of the contents based on the obtained command.

5. The information sharing apparatus according to claim 1, wherein
the message is exchanged by an instant messenger.

6. The information sharing apparatus according to claim 5, wherein
the instant messenger uses an eXtensible Messaging and Presence Protocol (XMPP).

7. An information sharing system comprising:
a plurality of information sharing apparatuses for sharing an operation on contents with one another; and
a server, which can deliver a message to the plurality of information sharing apparatuses, wherein the information sharing system includes
a registering part for registering the information sharing apparatuses,
a generating part configured to generate a message containing a command corresponding to the operation on the contents;
a delivering part configured to deliver the message, through the server, to the information sharing apparatuses registered by the registering part;
an interpreting part configured to interpret the message to obtain the command; and
an updating part configured to update a display of the contents based on the obtained command.

8. The information sharing system according to claim 7, wherein
the command corresponds to at least one of operations of designating the contents, of designating a display page of the contents, of adding a graphic or a character to the contents, of deleting the graphic or the character from the contents, and of adding handwritten data to the contents.

9. The information sharing system according to claim 8, wherein
the generating part generates the message capable of being interpreted by at least one of the information sharing apparatuses, which does not include the generating part.

10. The information sharing system according to claim 9, wherein
the updating part updates a data structure of the contents based on the obtained command.

11. The information sharing system according to claim 7, wherein
the message is exchanged by an instant messenger.

12. The information sharing system according to claim 11, wherein
the instant messenger uses an eXtensible Messaging and Presence Protocol (XMPP).

13. A method of processing information of sharing an operation on contents between apparatuses, the method of processing the information comprising:
generating a message containing a command corresponding to the operation on the contents;
sending the message from one of the apparatuses to a server, which delivers the message to another one of the apparatuses;
interpreting the message to obtain the command; and
updating a display of the contents based on the obtained command.
